(19) United States
(12) Patent Application Publication
(10) Pub. No.: US 2018/0139673 A1
(43) Pub. Date: May 17, 2018

(54) Methods and Apparatus for Controlling Mobility in a Wireless Network

(71) Applicant: Telefonaktiebolaget LM Ericsson (publ), Stockholm (SE)

(72) Inventor: Janne Peisa, Espoo (FI)

(21) Appl. No.: 15/528,545

(22) PCT Filed: Apr. 11, 2017
(86) PCT No.: PCT/SE2017/050360

§ 371 Date: May 22, 2017

Related U.S. Application Data
(60) Provisional application No. 62/334,779, filed on May 11, 2016.

(51) Int. Cl. H04W 36/30; H04W 36/00; H04W 36/06; H04W 72/08

(52) U.S. Cl. CPC H04W 36/30; H04W 36/0027; H04W 76/27; H04W 72/085; H04W 72/082; H04W 36/06

(57) ABSTRACT

According to some exemplary embodiments, a terminal device measures a quality of a radio link between the terminal device and one or more candidate radio access nodes, candidate cells or candidate beams. During a network-controlled mobility procedure relating to handover of the terminal device from a first radio access node, a first cell or a first beam to a second radio access node, second cell or a second beam, the first and second radio access nodes, cells or beams being different than the one or more candidate radio access nodes, cells or beams, responsive to a determination that a quality of a radio link between the terminal device and at least one of the first and second radio access nodes, cells or beams, does not meet a first quality criterion, the terminal device attempts to connect to one or more of the candidate radio access nodes, candidate cells or candidate beams for which the radio link has a measured quality that meets a second quality criterion.

### TECHNICAL FIELD

Examples of the present disclosure relate to methods and apparatus in a wireless network, and particularly relate to methods and apparatus for controlling mobility in a wireless network.

### BACKGROUND

In order to meet the future traffic demands and to support new use cases, 3GPP has started to specify a new radio access interface (NR) for 5G. It is expected that NR will also operate in higher frequencies than current mobile networks, perhaps even in the millimeter waves (for example, some of the potential candidates for NR bands include a 28 GHz frequency band).

Current mobility mechanisms are based on network (NW) control. For example, in Long Term Evolution (LTE) systems, mobility is based on the NW configuring a user equipment (UE) to perform mobility measurements, which trigger the UE to report measurement results, before the NW finally orders the UE to change cell with a suitable handover command (e.g. RRC Connection Reconfiguration). See FIGS. 1A to 1C.

The use of higher frequencies poses several challenges compared to lower frequencies, such as:

limited diffraction

limited building penetration

rain and atmospheric attenuation

increased body loss.

These challenges can lead to sudden drop of the signal strength.

One consequence of this sudden deterioration in the serving beam quality is an increased likelihood of at least one part of the handover procedure failing to complete correctly. This increase in likelihood is especially pronounced for network-controlled mobility mechanisms, such as those used in LTE.

### SUMMARY

In order to avoid handover failure due to sudden drop of signal quality, the proposals set out herein adopt a hybrid procedure which combines NW- and UE-controlled mobility mechanisms in a single solution.

In one aspect of the present disclosure, there is provided a method of operating a terminal device. The method comprises: measuring a quality of a radio link between the terminal device and one or more candidate radio access nodes, candidate cells or candidate beams; and during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, responsive to a determination that a quality of a radio link between the terminal device and at least one of the first radio access node, the first cell, the first beam, the second radio access node, the second cell and the second beam does not meet a first quality criterion, attempting to connect to one or more of the candidate radio access nodes, candidate cells or candidate beams for which the radio link has a measured quality that meets a second quality criterion.

In another aspect, there is provided a terminal device. The terminal device is configured to: measure a quality of a radio link between the terminal device and one or more candidate radio access nodes, candidate cells or candidate beams; and during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

In a further aspect, there is provided a terminal device. The terminal device comprises at least one antenna, processor circuitry and a computer-readable storage medium. The computer-readable storage medium stores instructions that are executable by the processor circuitry whereby the terminal device is operative to: measure a quality of a radio link between the terminal device and one or more candidate radio access nodes, candidate cells or candidate beams; and during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

In a yet further aspect, there is provided a terminal device. The terminal device comprises: a first module configured to measure a quality of a radio link between the terminal device and one or more candidate radio access nodes, candidate cells or candidate beams; and a second module configured to, during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

In another aspect, there is provided a method of operating a network node in a communication network. The method comprises: causing the transmission, to a terminal device, of a list identifying one or more candidate radio access nodes, candidate cells, or candidate beams that the terminal device is to use for a terminal-device-controlled mobility procedure in the event that a network-controlled mobility procedure fails.

The disclosure further provides a network node for a wireless communications network. The network node is configured to: cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

In another aspect, there is provided a network node. The network node comprises processor circuitry and a computer-readable storage medium. The computer-readable storage medium stores instructions that are executable by the processor circuitry whereby the network node is operative to: cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

The disclosure also provides a network node for a wireless communications network. The network node comprises: a first module configured to cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

According to an example of the disclosure, the baseline mobility procedure is fully network controlled, while the terminal device is provided with a limited set of candidate beams/cells for quick connection reestablishment in case the handover procedure fails. The terminal device measures the candidate beams/cells along with the detected beams/cells and if the radio link quality during the handover procedure suddenly deteriorates, the terminal device attempts to connect to any of the candidate beams/cells having sufficiently good quality.

Examples of the disclosure provide the main benefits of NW controlled mobility during normal operation, i.e. possibility for load sharing, consistent terminal device behaviour, but additionally provide benefits of terminal-device-controlled mobility, i.e. quick reaction to sudden changes in radio link quality. Examples of the disclosure also limit the amount of resources reserved for terminal-device-based mobility, by providing only a limited set of candidate beams/cells.

It should be noted that, although the methods and apparatus set forth are described largely in the context of LTE and networks that may be suitable for providing radio communications meeting one or more of the criteria established by the Next Generation Mobile Networks Alliance for the 5 th generation of mobile telecommunications standards (5G), the concepts disclosed herein are in no way limited to LTE or 5G, and are applicable to any wireless communication system.

### BRIEF DESCRIPTION OF THE DRAWINGS

For a better understanding of examples of the present disclosure, and to show more clearly how the examples may be carried into effect, reference will now be made, by way of example only, to the following drawings in which:

FIGS. 1A to 1C show a signalling diagram of a handover procedure in LTE;

FIG. 2 is a flowchart of a method in accordance with examples of the disclosure;

FIG. 3 is a flowchart of another method in accordance with examples of the disclosure;

FIG. 4 is a signalling diagram in accordance with examples of the disclosure;

FIG. 5 is another signalling diagram in accordance with examples of the disclosure;

FIG. 6 is a schematic drawing of a terminal device in accordance with examples of the disclosure;

FIG. 7 is a schematic drawing of a network node in accordance with examples of the disclosure;

FIG. 8 is a schematic drawing of a terminal device in accordance with examples of the disclosure; and

FIG. 9 is a schematic drawing of a network node in accordance with examples of the disclosure.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Although the terms “wireless device” or “terminal device” may be used in the description, it is noted that these terms encompass other terms used to denote wireless devices, such as user equipment (UE). It should be understood by the person skilled in the art that “UE” is a non-limiting term comprising any mobile or wireless device or node equipped with a radio interface allowing for at least one of: transmitting signals in uplink (UL), receiving and/or measuring signals in downlink (DL), and transmitting and/or receiving signals in a D2D/sidelink mode. A wireless device herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “wireless device” or “UE”, the terms “mobile device” and “terminal device” may be used interchangeably in the description, and it will be appreciated that such a device does not necessarily have to be ‘mobile’ in the sense that it is carried by a user. Instead, the term “mobile device” encompasses any device that is capable of communicating with communication networks that operate according to one or more mobile communication standards, such as the Global System for Mobile communications, GSM, Universal Mobile Telecommunications System (UMTS), Long-Term Evolution, LTE, etc.

It should be noted that use of the term “radio access node” as used herein can refer to a base station, such as an eNodeB, a network node in the RAN responsible for resource management, such as a radio network controller (RNC), or, in some cases, a core network node, such as a mobility management entity (MME), a ProSe function (ProSe-F) node or a ProSe Application Server. The term “network node” encompasses radio access nodes, and also nodes within or accessible via a core network. For example, a network node may comprise a server that is located remote from a radio access node, but receives data signals from the radio access node and provides control signals for the radio access node. This latter example reflects the increasing trend in telecommunications systems for functionality to be removed to servers operating in “the cloud”.

A wireless communications network comprises radio access nodes providing radio coverage over at least one respective geographical area forming what may be known as a “cell”. The cell definition may also incorporate frequency bands used for transmissions, which means that two different cells may cover the same geographical area but use different frequency bands. Future wireless networks may depart from or expand upon such conventional terminology. For example, a cell may comprise multiple directional beams that provide radio coverage to different parts of the cell. The radio access node serving such a cell may comprise a plurality of antennas such that one or more respective antennas are configured to provide each respective beam. Alternatively, the “cell” terminology may be abandoned altogether such that a radio access node provides only beams with no particular correspondence to a cell.

Terminal devices are served in the cells or beams by the respective radio access node and communicate with the respective radio access node. The terminal devices transmit data over an air or radio interface to the radio access nodes in uplink (UL) transmissions and the radio access nodes transmit data over an air or radio interface to the UEs in downlink (DL) transmissions.

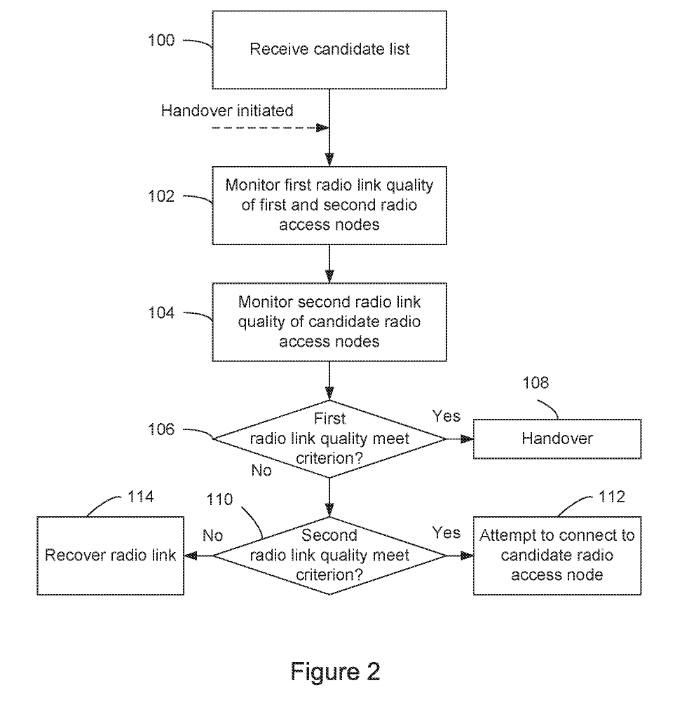

FIG. 2 is a flowchart of a method in accordance with examples of the disclosure. The method may be carried out, for example, in a terminal device of a wireless communications network.

In step 100, the terminal device receives a candidate list setting out a list identifying one or more candidate radio access nodes, candidate cells, or candidate beams that the terminal device is to use for a terminal-device-controlled mobility procedure in the event that a network-controlled mobility procedure fails.

For example, the candidate list may be received in a wireless signal transmitted by a radio access node, such as the radio access node serving the terminal device. The candidate list may be transmitted as part of a control signal, such as a measurement configuration signal. The measurement configuration signal may be an RRC connection reconfiguration message, for example. The measurement configuration signal may also contain conventional measurement configuration information, such as measurement triggering criteria, measurement quality, etc.

The candidate list may comprise an indication of the identities of one or more radio access nodes, or one or more cells served by those radio access nodes, or one or more beams, as described above. The candidate list may comprise all such radio access nodes, cells, or beams within a given geographical area. Alternatively, the candidate list may comprise all radio access nodes, cells, or beams within a given area that are capable of providing a given service to the terminal device. For example, the candidate list may comprise a list of all radio access nodes, cells, or beams capable of communicating with the terminal device using a particular radio access technology, such as a 5G radio access technology.

At some point, a handover procedure is initiated by the network with which the terminal device is associated, or by the terminal device itself. The candidate list will generally have been provided to the terminal device prior to initiation of the handover procedure; however, in some examples of the disclosure the candidate list may be provided to the terminal device during the handover procedure or even as a part of that handover procedure. The handover procedure is network controlled.

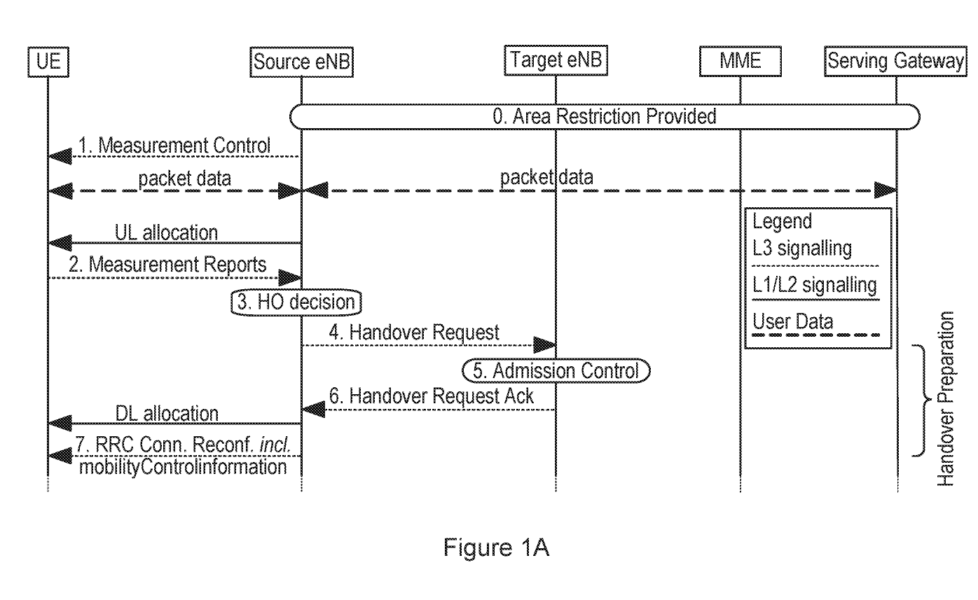

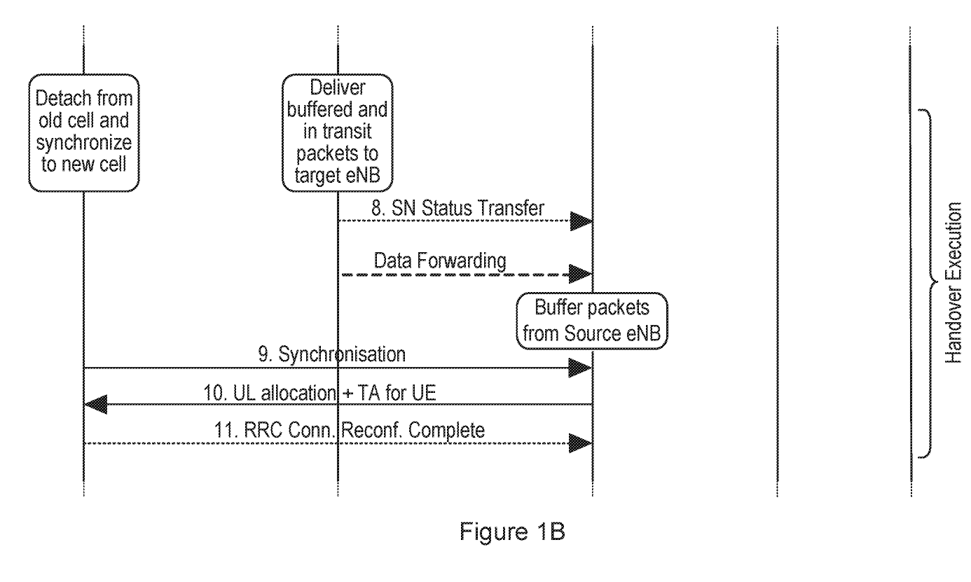

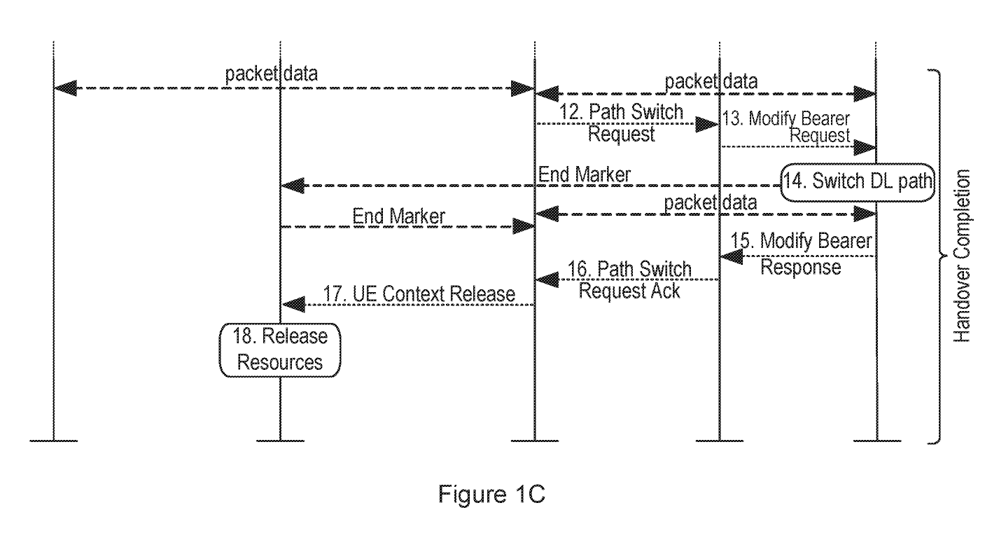

An example of the signalling associated with a conventional handover procedure is shown in FIGS. 1A to 1C. However, the present disclosure is not limited to any particular handover procedure. In general terms, the network-controlled handover procedure comprises an entity (whether the terminal device, a serving radio access node or any other device) identifying that the terminal device should be served by a different, “target” radio access node (or a target cell, or a target beam). The network-controlled handover procedure may begin, as far as the terminal device is concerned, with an appropriate signal received by the terminal device from the radio access node. The network-controlled handover procedure may end with a confirmation message from the target radio access node (to the terminal device, or to the serving radio access node) indicating that the target radio access node (or the target cell or target beam) is now serving the terminal device.

Note that, in examples where the candidate list is signalled to the terminal device in step 100, the candidate list may be signalled to the terminal device by the serving radio access node of the handover procedure, or a different radio access node (e.g. a radio access node that previously served the terminal device).

In step 102, during the network-controlled handover procedure, the terminal device monitors the radio link quality (termed herein the “first” radio link quality) between the terminal device and one or more of the serving radio access node (or the serving cell or serving beam) and the target radio access node (or the target cell or target beam). In one example, the terminal device monitors the radio link quality between the terminal device and only the serving radio access node (or the serving cell or serving beam).

The radio link quality may be measured in a number of different ways. For example, the radio link quality may comprise one or more of: a signal strength of signals transmitted by the radio access node and received at the terminal device; a signal-to-noise ratio for signals transmitted by the radio access node and received at the terminal device; a signal-to-interference-plus-noise ratio for signals transmitted by the radio access node and; and a number of re-transmission attempts of a transport packet transmitted by the radio access node and received at the terminal device (or vice versa).

In step 104, the terminal device additionally monitors the radio link quality (termed herein the “second” radio link quality) between the terminal device and one or more of the candidate radio access nodes (or candidate cells or candidate beams) contained in the candidate list. In one example, the terminal device monitors the radio link quality between the terminal device and all candidate radio access nodes in the candidate list.

The terminal device may further measure the radio link quality between the terminal device and all other detected radio access nodes (or all other detected cells, or beams), even if they are not on the candidate list.

Note that, in some examples of the disclosure, step 104 may take place prior to the initiation of the handover process. That is, the terminal device may monitor the radio link quality with candidate radio access nodes (or cells, or beams) before handover is initiated, e.g. on an on-going basis. In other examples, step 104 may take place after step 106. See below.

In step 106, the terminal device determines whether or not the first radio link quality, measured in step 102, meets a first quality criterion. The terminal device may continue to make such a determination throughout the network-controlled handover procedure.

In alternative examples, step 106 may comprise receiving an indication from a radio access node (such as the serving radio access node or a target radio access node) that the first radio link quality fails to meet the first quality criterion.

The first quality criterion may comprise one or more threshold values against which the first radio link quality is to be compared. For example, the first quality criterion may comprise a threshold value of signal strength, against which the signal strength of signals transmitted by the radio access node and received at the terminal device should be compared. The first quality criterion may comprise a threshold value of signal-to-noise ratio, against which the measured value of signal-to-noise ratio should be compared. The first quality criterion may comprise a threshold value of signal-to-interference-plus-noise ratio, against which the measured value of signal-to-interference-plus-noise ratio should be compared. The first quality criterion may comprise a threshold value for the number of re-transmission attempts, against which the measured number of re-transmission attempts should be compared.

The first quality criterion may be configured such that a failure to meet the first quality criterion represents failure of the radio link between the terminal device and at least one of the serving radio access node (or cell, or beam) and the target radio access node (or cell, or beam).

The first quality criterion may be signalled to the terminal device, or coded into the memory of the terminal device (e.g. hard-coded during manufacture of the device). In the former example, the first quality criterion may be indicated in a wireless signal received by the terminal device, such as the measurement configuration signal received in step 100 according to certain examples. In other examples, the first quality criterion may be contained in a different signal.

If the first radio link quality meets the first quality criterion (and continues to meet the first quality criterion throughout the handover procedure), the radio link with the network is adequate and the handover procedure can continue to its conclusion in step 108. Thus the terminal device is handed over from a serving radio access node (or cell, or beam) to a target radio access node (or cell, or beam).

If, in step 106, it is determined that the first radio link quality fails to meet the first quality criterion, the process moves to step 110 in which the terminal device determines whether the second radio link quality, measured in step 104, for one or more of the candidate radio access nodes (or cells or beams), meets a second quality criterion. In one example, the terminal device determines whether the second radio link quality, for any of the candidate radio access nodes (or cells or beams), meets the second quality criterion.

The second quality criterion may comprise one or more threshold values against which the second radio link quality is to be compared. For example, the second quality criterion may comprise a threshold value of signal strength, against which the signal strength of signals transmitted by the radio access node and received at the terminal device should be compared. The second quality criterion may comprise a threshold value of signal-to-noise ratio, against which the measured value of signal-to-noise ratio should be compared. The second quality criterion may comprise a threshold value of signal-to-interference-plus-noise ratio, against which the measured value of signal-to-interference-plus-noise ratio should be compared. The second quality criterion may comprise a threshold value for the number of re-transmission attempts, against which the measured number of re-transmission attempts should be compared.

The second quality criterion may be the same as, or different than the first quality criterion. That is, in examples where the first and second quality criteria comprise thresholds, the values for the thresholds of the second quality criterion may be the same as, or different than, the values of the thresholds of the first quality criterion. In one example, the values of the thresholds of the second quality criterion are higher than the corresponding values of the first quality criterion, such that the radio link quality must be higher in order to meet the second quality criterion than the first quality criterion.

The second quality criterion may be signalled to the terminal device, or coded into the memory of the terminal device (e.g. hard-coded during manufacture of the device). In the former example, the second quality criterion may be indicated in a wireless signal received by the terminal device, such as the measurement configuration signal received in step 100 according to certain examples. In other examples, the second quality criterion may be contained in a different signal, such as the signal in which the first quality criterion is contained.

Note that step 104, in which the second radio link quality is measured, may take place after step 106 according to some examples, in the event that the first radio link quality fails to meet the first quality criterion. That is, the terminal device only measures the second radio link quality responsive to a determination that the first radio link quality fails to meet the first quality criterion.

If the second radio link quality does not meet the second quality criterion, and particularly if the radio link quality for all candidate radio access nodes (or cells, or beams) fails to meet the second quality criterion, the method proceeds to step 114 in which the terminal device attempts to recover the radio link. For example, the terminal device may attempt to recover the radio link with the serving radio access link. Conventional processes may be used to recover the link in this instance.

If the radio link quality for one or more of the candidate radio access nodes (or cells, or beams) does meet the second quality criterion, the method proceeds to step 112 in which the terminal device initiates a terminal-device-controlled handover procedure, and attempts to connect to one or more of the candidate radio access nodes (or cells, or beams) that meet the second quality criterion. In one example, the terminal device attempts to connect to all candidate radio access nodes (or cells, or beams) that meet the second quality criterion. In another example, the terminal device attempts to connect to one or more of the candidate radio access nodes (or cells, or beams) that meet the second quality criterion and have the highest values of radio link quality.

The attempts to connect to the candidate radio access node(s) (or cell(s) or beam(s)) may comprise transmitting a random access signal (RACH) to the candidate radio access node(s) in question. For example, the RACH signal may indicate to the candidate radio access node that the terminal device wishes to connect to it.

The terminal device may subsequently transmit a connection request to the candidate radio access node(s) (or cell(s) or beam(s)). The connection request may take the form of an RRC Connection reestablishment request signal.

Upon acceptance of the connection request by the candidate radio access node, the terminal device may receive a connection acceptance signal from the candidate radio access node, indicating that the connection request has been accepted, i.e. handover to the candidate radio access node (or cell, or beam) has been completed. The terminal device may then communicate directly with the candidate radio access node (or cell, or beam).

FIG. 2 thus sets out the steps of a method in which a terminal device can monitor the quality of a radio link with serving and/or target radio access nodes, and then initiate its own terminal-device-controlled handover procedure in the event that the radio link quality fails to meet a particular quality criterion.

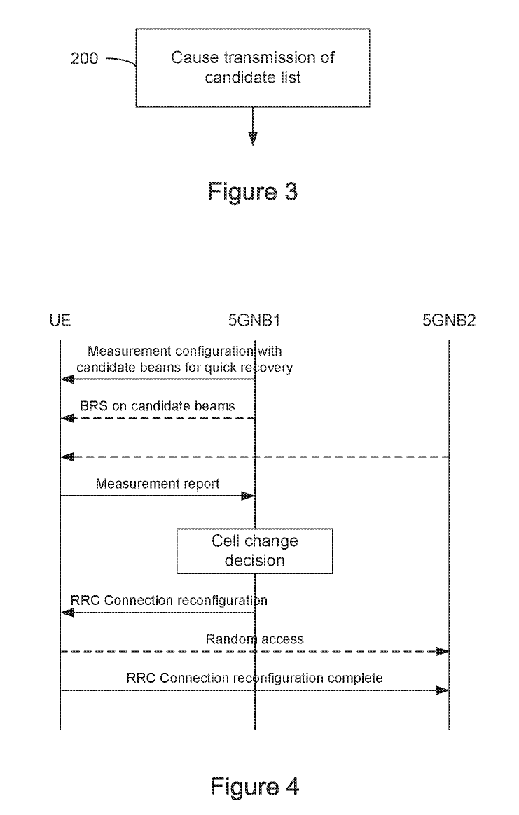

FIG. 3 is a flowchart of another method in accordance with examples of the disclosure. The method may be carried out, for example, in a network node of a wireless communications network. The network node may be a radio access node, or a server in communication with a radio access node, that is located remote from the radio access node, but receives data signals from the radio access node and provides control signals for the radio access node.

In step 200, the network node causes transmission, by a radio access node, of a candidate list to a terminal device associated with the wireless communications network. The candidate list sets out a list identifying one or more candidate radio access nodes, candidate cells, or candidate beams that the terminal device is to use for a terminal-device-controlled mobility procedure in the event that a network-controlled mobility procedure fails. The radio access node transmitting the candidate list may or may not be the serving radio access node involved in the network-controlled mobility procedure.

In examples where the network node performing the method is the radio access node, the network node may cause transmission of the candidate list using its processor circuitry, transceiver circuitry, and one or more antennas. In examples where the network node performing the method is a server located remotely from the radio access node, the network node may cause transmission of the candidate list by transmitting a suitable control signal to the radio access node (which in turn transmits the candidate list to the terminal device).

The candidate list may comprise an indication of the identities of one or more radio access nodes, or one or more cells served by those radio access nodes, or one or more beams, as described above. The candidate list may comprise all such radio access nodes, cells, or beams within a given geographical area. Alternatively, the candidate list may comprise all radio access nodes, cells, or beams within a given area that are capable of providing a given service to the terminal device. For example, the candidate list may comprise a list of all radio access nodes, cells, or beams capable of communicating with the terminal device using a particular radio access technology, such as a 5G radio access technology.

The candidate list may be transmitted as part of a control signal. such as a measurement configuration signal. Such a measurement configuration signal may also contain conventional measurement configuration information, such as measurement triggering criteria, measurement quality, etc.

The method may additionally comprise the step of causing transmission, by the radio access node, of first and/or second quality criteria to the terminal device. The first and/or second quality criteria may be transmitted to the terminal device at the same time as the candidate list, for example as part of the same measurement configuration signal, or at a different time as part of a different signal.

The first quality criterion may comprise one or more threshold values against which the terminal device is to compare, during a handover procedure, the radio link quality between the terminal device and at least one of a serving radio access node (or cell, or beam) and a target radio access node (or cell, or beam). For example, the first quality criterion may comprise a threshold value of signal strength, against which the signal strength of signals transmitted by the radio access node and received at the terminal device should be compared. The first quality criterion may comprise a threshold value of signal-to-noise ratio, against which the measured value of signal-to-noise ratio should be compared. The first quality criterion may comprise a threshold value of signal-to-interference-plus-noise ratio, against which the measured value of signal-to-interference-plus-noise ratio should be compared. The first quality criterion may comprise a threshold value for the number of re-transmission attempts, against which the measured number of re-transmission attempts should be compared.

The first quality criterion may be configured such that a failure to meet the first quality criterion represents failure of the radio link between the terminal device and at least one of the serving radio access node (or cell, or beam) and the target radio access node (or cell, or beam).

Similarly, the second quality criterion may comprise one or more thresholds against which the terminal device is to compare, during a handover procedure, the radio link quality between the terminal device and one or more of the candidate radio access nodes (or cells, or beams) contained in the candidate list. The second quality criterion may be the same as, or different than the first quality criterion. That is, in examples where the first and second quality criteria comprise thresholds, the values for the thresholds of the second quality criterion may be the same as, or different than, the values of the thresholds of the first quality criterion. In one example, the values of the thresholds of the second quality criterion are higher than the corresponding values of the first quality criterion, such that the radio link quality must be higher in order to meet the second quality criterion than the first quality criterion.

Thus FIG. 3 describes a method in a network node of a wireless communications network, whereby a terminal device can be provided with a candidate list setting out a list identifying one or more candidate radio access nodes, candidate cells, or candidate beams that the terminal device is to use for a terminal-device-controlled mobility procedure in the event that a network-controlled mobility procedure fails. The terminal device is thus enabled to control a handover process in the event that a network-controlled handover process fails.

FIG. 4 is a signalling diagram in accordance with examples of the disclosure.

The terminal device is given the acronym, UE. The serving radio access node is given the acronym 5GNB1. The target radio access node is given the acronym 5GNB2.

In a first signal the serving radio access node 5GNB1 transmits a measurement configuration signal to the terminal device. The measurement configuration signal contains a candidate list as defined above, and may additional contain an indication of the first and second quality criteria.

The serving and target radio access nodes transmit or broadcast reference signals which are received and measured by the terminal device. The reference signals may be beam reference signals (BRS) in some examples.

The terminal device measures the reference signals and transmits a measurement report to the serving radio access node. The measurement report may be triggered only in certain situations (such as a large disparity in radio quality between a serving radio access node and one or more other radio access nodes), which may be defined in the measurement configuration signal. The measurement report may contain an indication of the radio link qualities to the serving and target radio access nodes. The radio link qualities may be defined in a number of ways, such as one or more of: a signal strength of signals transmitted by the radio access node and received at the terminal device; a signal-to-noise ratio for signals transmitted by the radio access node and received at the terminal device; a signal-to-interference-plus-noise ratio for signals transmitted by the radio access node and; and a number of re-transmission attempts of a transport packet transmitted by the radio access node and received at the terminal device (or vice versa).

A cell change decision is subsequently made by the network, using any of the various known methods for determining handover, based on the data in the measurement report. The cell change decision may be taken by the serving radio access node, or another node of the network in communication with the serving radio access node (such as a mobility management entity, for example).

The serving radio access node transmits a suitable control signal to the terminal device initiating the handover process to the target radio access node. In the illustrated example, the control signal is an RRC Connection reconfiguration control signal; however, other signals may be used (e.g. in networks other than LTE networks).

Upon receipt of the control signal, the terminal device transmits a random access signal (RACH) to the target radio access node, and subsequently a control signal indicating that the handover procedure is complete. In the illustrated example, the control signal is an RRC Connection reconfiguration complete signal; however, other signals may be used.

The signalling in FIG. 4 thus represents control of a mobility procedure when the radio link quality between the terminal device and the serving radio access node or the target radio access node remains acceptable (i.e. meeting the first quality criterion). The network therefore remains in control of the mobility procedure throughout.

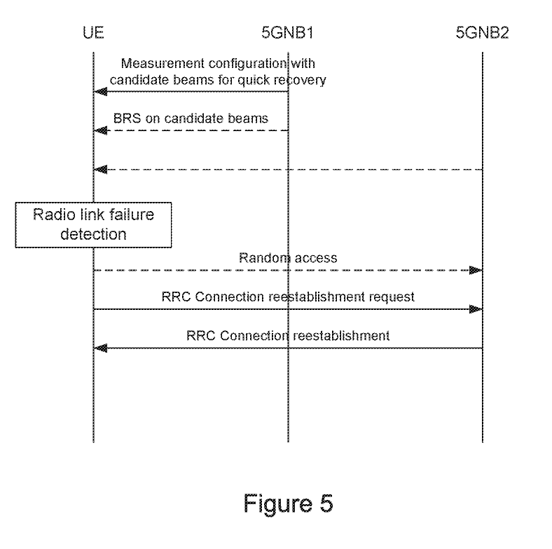

FIG. 5 is another signalling diagram in accordance with examples of the disclosure, wherein the radio link quality between the terminal device and the serving radio access node or the target radio access node becomes unacceptable (i.e. failing to meet the first quality criterion).

The terminal device is again given the acronym, UE, and the serving radio access node is again given the acronym 5GNB1, The acronym 5GNB2, however, is instead given to a candidate radio access node, as defined above.

In a first signal the serving radio access node 5GNB1 transmits a measurement configuration signal to the terminal device. The measurement configuration signal contains a candidate list as defined above, and may additionaly contain an indication of the first and second quality criteria.

The serving and target radio access nodes transmit or broadcast reference signals which are received and measured by the terminal device. The reference signals may be beam reference signals (BRS) in some examples.

The terminal device measures the reference signals and determines the radio link qualities to the serving, target and candidate radio access nodes. The radio link qualities may be defined in a number of ways, such as one or more of: a signal strength of signals transmitted by the radio access node and received at the terminal device; a signal-to-noise ratio for signals transmitted by the radio access node and received at the terminal device; a signal-to-interference-plus-noise ratio for signals transmitted by the radio access node and; and a number of re-transmission attempts of a transport packet transmitted by the radio access node and received at the terminal device (or vice versa).

However, at this point the radio link quality between the terminal device and the serving radio access node or the target radio access node becomes unacceptable (i.e. fails to meet the first quality criteria). For example, the terminal device may determine such an acceptable radio link quality based on the reference signals transmitted by the serving and target radio access nodes. The terminal device thus determines, in the illustrated example, that the radio link has failed, and initiates its own terminal-device-controlled mobility procedure (i.e. handover).

The terminal device knows the quality of the radio link with the candidate radio access node 5GNB2, and determines that the quality meets the second quality criterion. In response to such a determination, the terminal device transmits a signal, which may be a random access signal (RACH), to the candidate radio access node. The signal may contain an indication that the terminal device intends to attempt to connect with the candidate radio access node and may contain, for example, an indication of the identity of the terminal device. The candidate radio access node may then, in response, reserve resources for the terminal device.

Subsequently, the terminal device may transmit a request to connect signal to the candidate radio access node. The request to connect signal may contain an identity of the terminal device, and an indication of the context of the terminal device. In the illustrated example, the request to connect signal comprises an RRC Connection reestablishment request.

The candidate radio access node subsequently transmits a confirmation signal to the terminal device indicating that the handover procedure is complete. The terminal device is then successfully handed over to the candidate radio access node and may continue communicating with the candidate radio access node to provide services to its user. In the illustrated example, the confirmation signal comprises an RRC Connection reestablishment signal.

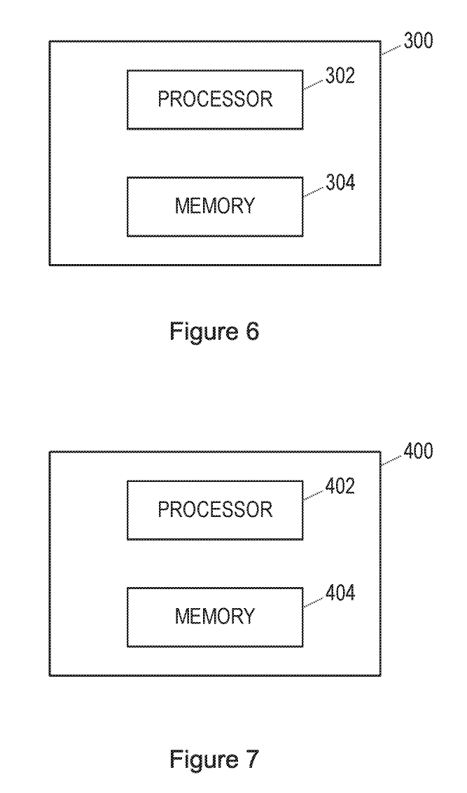

FIG. 6 shows a terminal device 300 according to an example of the present disclosure. The terminal device 300 may be suitable for carrying out the method described above with respect to FIG. 2.

The terminal device 300 comprises a processor 302 and a memory 304. The memory 304 contains instructions executable by the processor 302. The terminal device 300 is operative to measure a quality of a radio link between the terminal device and one or more candidate radio access nodes, candidate cells or candidate beams. During a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, and responsive to a determination that a quality of a radio link between the terminal device and at least one of the first radio access node, the first cell, the first beam, the second radio access node, the second cell and the second beam does not meet a first quality criterion, the terminal device 300 is operative to attempt to connect to one or more of the candidate radio access nodes, candidate cells or candidate beams for which the radio link has a measured quality that meets a second quality criterion.

FIG. 7 shows a network node 400 according to an example of the present disclosure. The network node 400 may be suitable for carrying out the method described in FIG. 3. The network node 400 comprises a processor 402 and a memory 404. The memory 404 contains instructions executable by the processor 402. The network node 400 is operative to cause the transmission, to a terminal device, of a list identifying one or more candidate radio access nodes, candidate cells, or candidate beams that the terminal device is to use for a terminal-device-controlled mobility procedure in the event that a network-controlled mobility procedure fails. In order to cause transmission of the list, the network node may transmit the list using transceiver circuitry and/or one or more antennas located in the network node (e.g. in examples where the network node is a radio access node), or send one or more control instructions to a radio access node for the radio access node to transmit the list using its own transceiver circuitry and one or more antennas (e.g. in examples where the network node 400 is a server located remotely from the radio access node).

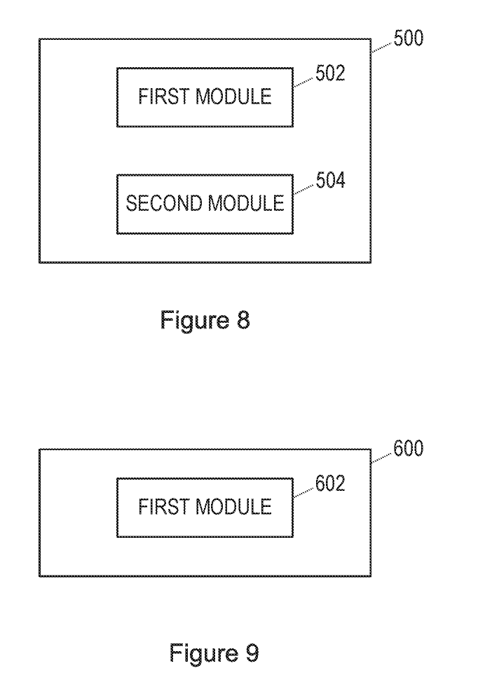

FIG. 8 shows a terminal device 500 according to an example of the present disclosure. The terminal device 500 may be suitable for carrying out the method described above with respect to FIG. 2.

The network node 500 comprises a first module 502 and a second module 504. The first module 502 is configured to measure a quality of a radio link between the terminal device and one or more candidate radio access nodes, candidate cells or candidate beams. The second module 504 is configured to, during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

FIG. 9 shows a network node 600 according to an example of the present disclosure. The network node 600 may be suitable for carrying out the method described in FIG. 3. The network node 600 comprises a first module 602. The first module 602 is configured to cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

The present disclosure thus provides apparatus and methods for controlling mobility in a wireless network. In particular, the disclosure provides methods that comprise a hybrid procedure for handover operations, whereby the network controls handover in the first instance, but the terminal device controls handover in the event that a radio link quality drops during the network-controlled procedure.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

### SOME EXAMPLE EMBODIMENTS

1. A method of operating a terminal device, the method comprising:

measuring a quality of a radio link between the terminal device and one or more candidate radio access nodes, candidate cells or candidate beams; and

during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams,

responsive to a determination that a quality of a radio link between the terminal device and at least one of the first radio access node, the first cell, the first beam, the second radio access node, the second cell and the second beam does not meet a first quality criterion, attempting to connect to one or more of the candidate radio access nodes, candidate cells or candidate beams for which the radio link has a measured quality that meets a second quality criterion.

2. The method as set out in paragraph 1, wherein the quality of the radio link comprises one or more of: a signal strength received at the terminal device; a signal-to-noise ratio for signals received at the terminal device; a signal-to-interference-plus-noise ratio; and a number of re-transmission attempts of a transport packet received at the terminal device.

3. The method as set out in paragraph 1 or 2, wherein the first quality criterion comprises one or more threshold values for the quality of the radio link between the terminal device and at least one of the first radio access node, the first cell, the first beam, the second radio access node, the second cell and the second beam.

4. The method as set out in any preceding claim, wherein a failure to meet the first quality criterion represents failure of the radio link between the terminal device and at least one of the first radio access node, the first cell, the first beam, the second radio access node, the second cell and the second beam.

5. The method as set out in any preceding paragraph, wherein the second quality criterion comprises one or more threshold values for the quality of the radio link between the terminal device and the one or more candidate radio access nodes, candidate cells or candidate beams.

6. The method as set out in any one of the preceding paragraphs, wherein the second quality criterion is the same as or different than the first quality criterion.

7. The method as set out in any one of the preceding paragraphs, further comprising:

receiving a list of candidate radio access nodes, candidate cells or candidate beams.

8. The method as set out in paragraph 7, wherein the list of candidate radio access nodes, candidate cells or candidate beams is received from a radio access node.

9. The method as set out in paragraph 8, wherein the list of candidate radio access nodes, candidate cells or candidate beams is received from the first radio access node.

10. The method as set out in any one of the preceding paragraphs, further comprising:

receiving a control signal containing an indication of one or more of the first and second quality criteria.

11. The method as set out in paragraph 10, wherein the control signal is received from a radio access node.

12. The method as set out in paragraph 11, wherein the radio access node is the first radio access node.

13. The method as set out in any one of paragraphs 1 to 9, wherein at least one of the first and second quality criteria are contained in code stored on the terminal device.

14. The method as set out in any one of the preceding paragraphs, wherein the first radio access node serves the first cell, and wherein the first cell comprises one or more first beams.

15. The method as set out in any one of the preceding paragraphs, wherein the step of measuring the quality of a radio link between the terminal device and one or more candidate radio access nodes, candidate cells or candidate beams is carried out responsive to the determination that the quality of the radio link between the terminal device and the at least one of the first radio access node, the first cell, the first beam, the second radio access node, the second cell and the second beam does not meet the first quality criterion.

16. The method as set out in any one of the preceding paragraphs, wherein the step of attempting to connect to one or more of the candidate radio access nodes, candidate cells or candidate beams is carried out responsive to a determination that the quality of the radio link between the terminal device and the at least one of the first radio access node, the first cell and the first beam does not meet the first quality criterion.

17. The method as set out in any one of the preceding paragraphs, wherein the step of attempting to connect to one or more of the candidate radio access nodes, candidate cells or candidate beams comprises transmitting a random access signal to the one or more of the candidate radio access nodes, candidate cells or candidate beams.

18. The method as set out in any one of the preceding paragraphs, wherein the step of attempting to connect to one or more of the candidate radio access nodes, candidate cells or candidate beams comprises transmitting an RRC re-establishment request signal to the one or more of the candidate radio access nodes, candidate cells or candidate beams.

19. The method as set out in any one of the preceding paragraphs, further comprising:

responsive to a determination that none of the candidate radio access nodes, candidate cells or candidate beams has a radio link quality meeting the second quality criterion, attempting to re-establish a radio link with the first radio access node, the first cell or the first beam.

20. A terminal device configured to:

measure a quality of a radio link between the terminal device and one or more candidate radio access nodes, candidate cells or candidate beams; and

during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams,

responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

21. The terminal device method as set out in paragraph 20, further configured to perform the method according to any one of paragraphs 2 to 19.

22. A terminal device comprising at least one antenna, processor circuitry and a computer-readable storage medium, the computer-readable storage medium storing instructions that are executable by the processor circuitry whereby the terminal device is operative to:

measure a quality of a radio link between the terminal device and one or more candidate radio access nodes, candidate cells or candidate beams; and

during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams,

responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

23. The terminal device as set out in paragraph 22, wherein the first quality criterion comprises one or more threshold values for the quality of the radio link between the terminal device and at least one of the first radio access node, the first cell, the first beam, the second radio access node, the second cell and the second beam.

24. The terminal device as set out in any paragraph 22 or 23, wherein a failure to meet the first quality criterion represents failure of the radio link between the terminal device and at least one of the first radio access node, the first cell, the first beam, the second radio access node, the second cell and the second beam.

25. The terminal device as set out in any one of paragraphs 22 to 24, wherein the second quality criterion comprises one or more threshold values for the quality of the radio link between the terminal device and the one or more candidate radio access nodes, candidate cells or candidate beams.

26. The terminal device as set out in any one of paragraphs 22 to 25, wherein the second quality criterion is the same as or different than the first quality criterion.

27. The terminal device as set out in any one of paragraphs 22 to 26, wherein instructions are executable by the processor circuitry such that the terminal device is further operative to:

receive a list of candidate radio access nodes, candidate cells or candidate beams.

28. The terminal device as set out in paragraph 27, wherein the list of candidate radio access nodes, candidate cells or candidate beams is received from a radio access node.

29. The terminal device as set out in paragraph 28, wherein the list of candidate radio access nodes, candidate cells or candidate beams is received from the first radio access node.

30. The terminal device as set out in any one of the paragraphs 22 to 29, wherein the instructions are executable by the processor circuitry such that the terminal device is further operative to:

receive a control signal containing an indication of one or more of the first and second quality criteria.

31. The terminal device as set out in paragraph 30, wherein the control signal is received from a radio access node.

32. The terminal device as set out in paragraph 31, wherein the radio access node is the first radio access node.

33. The terminal device as set out in any one of paragraphs 22 to 29, wherein at least one of the first and second quality criteria are contained in code stored on the terminal device.

34. The terminal device as set out in any one of paragraphs 22 to 33, wherein the first radio access node serves the first cell, and wherein the first cell comprises one or more first beams.

35. The terminal device as set out in any one of paragraphs 22 to 34, wherein the instructions are executable by the processor circuitry such that the terminal device is further operative to:

measure the quality of a radio link between the terminal device and one or more candidate radio access nodes, candidate cells or candidate beams responsive to the determination that the quality of the radio link between the terminal device and the at least one of the first radio access node, the first cell, the first beam, the second radio access node, the second cell and the second beam does not meet the first quality criterion.

36. The terminal device as set out in any one of paragraphs 22 to 35, wherein the instructions are executable by the processor circuitry such that the terminal device is further operative to:

attempt to connect to one or more of the candidate radio access nodes, candidate cells or candidate beams responsive to a determination that the quality of the radio link between the terminal device and the at least one of the first radio access node, the first cell and the first beam does not meet the first quality criterion.

37. The terminal device as set out in any one of paragraphs 22 to 36, wherein the instructions are executable by the processor circuitry such that the terminal device is further operative to:

transmit a random access signal to the one or more of the candidate radio access nodes, candidate cells or candidate beams.

38. The terminal device as set out in any one of paragraphs 22 to 37, wherein the instructions are executable by the processor circuitry such that the terminal device is further operative to:

transmit an RRC re-establishment request signal to the one or more of candidate radio access nodes, candidate cells or candidate beams.

39. The terminal device as set out in any one of paragraphs 22 to 38, wherein the instructions are executable by the processor circuitry such that the terminal device is further operative to:

responsive to a determination that none of the candidate radio access nodes, candidate cells or candidate beams has a radio link quality meeting the second quality criterion, attempt to re-establish a radio link with the first radio access node, the first cell or the first beam.

40. A terminal device, comprising:

a first module configured to measure a quality of a radio link between the terminal device and one or more candidate radio access nodes, candidate cells or candidate beams; and

a second module configured to, during a network-controlled mobility procedure relating to handover of the terminal device from a first radio access node, a first cell or a first beam, to a second radio access node, a second cell or a second beam, the first radio access node, the first cell, the first beam, the second radio access node, the second cell and the second beam being different than the one or more candidate radio access nodes, candidate cells or candidate beams, responsive to a determination that a quality of a radio link between the terminal device and at least one of the first radio access node, the first cell, the first beam, the second radio access node, the second cell and the second beam does not meet a first quality criterion, attempt to connect to one or more of the candidate radio access nodes, candidate cells or candidate beams for which the radio link has a measured quality that meets a second quality criterion.

41. The terminal device as set out in paragraph 40, wherein the first quality criterion comprises one or more threshold values for the quality of the radio link between the terminal device and at least one of the first radio access node, the first cell, the first beam, the second radio access node, the second cell and the second beam.

42. The terminal device as set out in paragraph 40 or 41, wherein a failure to meet the first quality criterion represents failure of the radio link between the terminal device and at least one of the first radio access node, the first cell, the first beam, the second radio access node, the second cell and the second beam.

43. The terminal device as set out in any one of paragraphs 40 to 42, wherein the second quality criterion comprises one or more threshold values for the quality of the radio link between the terminal device and the one or more candidate radio access nodes, candidate cells or candidate beams.

44. The terminal device as set out in any one of paragraphs 40 to 43, wherein the second quality criterion is the same as or different than the first quality criterion.

45. The terminal device as set out in any one of paragraphs 40 to 44, further comprising:

a third module configured to receive a list of candidate radio access nodes, candidate cells or candidate beams.

46. The terminal device as set out in paragraph 45, wherein the third module is configured to receive the list of candidate radio access nodes, candidate cells or candidate beams from a radio access node.

47. The terminal device as set out in paragraph 46, wherein the third module is configured to receive the list of candidate radio access nodes, candidate cells or candidate beams from the first radio access node.

48. The terminal device as set out in any one of the paragraphs 40 to 47, further comprising:

a fourth module configured to receive a control signal containing an indication of one or more of the first and second quality criteria.

49. The terminal device as set out in paragraph 48, wherein the control signal is received from a radio access node.

50. The terminal device as set out in paragraph 49, wherein the radio access node is the first radio access node.

51. The terminal device as set out in any one of paragraphs 50 to 47, wherein at least one of the first and second quality criteria are contained in code stored on the terminal device.

52. The terminal device as set out in any one of paragraphs 40 to 51, wherein the first radio access node serves the first cell, and wherein the first cell comprises one or more first beams.

53. The terminal device as set out in any one of paragraphs 40 to 52, wherein the first module is configured to measure the quality of a radio link between the terminal device and one or more candidate radio access nodes, candidate cells or candidate beams responsive to the determination that the quality of the radio link between the terminal device and the at least one of the first radio access node, the first cell, the first beam, the second radio access node, the second cell and the second beam does not meet the first quality criterion.

54. The terminal device as set out in any one of paragraphs 40 to 53, wherein the second module is configured to attempt to connect to one or more of the candidate radio access nodes, candidate cells or candidate beams responsive to a determination that the quality of the radio link between the terminal device and the at least one of the first radio access node, the first cell and the first beam does not meet the first quality criterion.

55. The terminal device as set out in any one of paragraphs 40 to 54, wherein the second module is configured to transmit a random access signal to the one or more of the candidate radio access nodes, candidate cells or candidate beams.

56. The terminal device as set out in any one of paragraphs 40 to 55, wherein the second module is configured to transmit an RRC re-establishment request signal to the one or more of the candidate radio access nodes, candidate cells or candidate beams.

57. The terminal device as set out in any one of paragraphs 40 to 56, further comprising:

a fifth module configured to, responsive to a determination that none of the candidate radio access nodes, candidate cells or candidate beams has a radio link quality meeting the second quality criterion, attempt to re-establish a radio link with the first radio access node, the first cell or the first beam.

58. A method of operating a network node in a communication network, the method comprising:

causing the transmission, to a terminal device, of a list identifying one or more candidate radio access nodes, candidate cells, or candidate beams that the terminal device is to use for a terminal-device-controlled mobility procedure in the event that a network-controlled mobility procedure fails.

59. The method as set out in paragraph 58, further comprising:

causing the transmission, to the terminal device, of a first criterion that the terminal device is to use in determining whether the network-controlled mobility procedure has failed.

60. The method as set out in paragraph 59, wherein the first criterion comprises one or more thresholds against which the terminal device is to compare a quality of a radio link to at least one of a serving radio access node, a serving cell, a serving beam, a target radio access node, a target cell, and a target beam.

61. The method as set out in any one of paragraphs 58 to 60, further comprising:

causing the transmission, to the terminal device, of a second criterion that the terminal device is to use in determining whether to attempt to connect to one or more of the candidate radio access nodes, candidate cells, or candidate beams during the terminal-device-controlled mobility procedure.

62. The method as set out in paragraph 61, wherein the second criterion comprises one or more thresholds against which the terminal device is to compare a quality of a radio link with one or more of the candidate radio access nodes, candidate cells, or candidate beams.

63. A network node for a wireless communications network, the network node being configured to:

cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

64. The network node as set out in paragraph 63, further configured to:

cause the transmission, to the terminal device, of a first criterion that the terminal device is to use in determining whether the network-controlled mobility procedure has failed.

65. The network node as set out in paragraph 64, wherein the first criterion comprises one or more thresholds against which the terminal device is to compare a quality of a radio link to at least one of a serving radio access node, a serving cell, a serving beam, a target radio access node, a target cell, and a target beam.

66. The network node as set out in any one of paragraphs 63 to 65, further configured to:

cause the transmission, to the terminal device, of a second criterion that the terminal device is to use in determining whether to attempt to connect to one or more of the candidate radio access nodes, candidate cells, or candidate beams during the terminal-device-controlled mobility procedure.

67. The network node as set out in paragraph 66, wherein the second criterion comprises one or more thresholds against which the terminal device is to compare a quality of a radio link with one or more of the candidate radio access nodes, candidate cells, or candidate beams.

68. A network node comprising processor circuitry and a computer-readable storage medium, the computer-readable storage medium storing instructions that are executable by the processor circuitry whereby the network node is operative to:

cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

69. The network node as set out in paragraph 68, wherein the instructions are executable by the processor circuitry such that the network node is further operative to:

cause the transmission, to the terminal device, of a first criterion that the terminal device is to use in determining whether the network-controlled mobility procedure has failed.

70. The network node as set out in paragraph 69, wherein the first criterion comprises one or more thresholds against which the terminal device is to compare a quality of a radio link to at least one of a serving radio access node, a serving cell, a serving beam, a target radio access node, a target cell, and a target beam.

71. The network node as set out n any one of paragraphs 68 to 70, wherein the instructions are executable by the processor circuitry such that the network node is further operative to:

cause the transmission, to the terminal device, of a second criterion that the terminal device is to use in determining whether to attempt to connect to one or more of the candidate radio access nodes, candidate cells, or candidate beams during the terminal-device-controlled mobility procedure.

72. The network node as set out in paragraph 71, wherein the second criterion comprises one or more thresholds against which the terminal device is to compare a quality of a radio link with one or more of the candidate radio access nodes, candidate cells, or candidate beams.

73. A network node for a wireless communications network, the network node comprising:

a first module configured to cause the transmission, to a terminal device, of a list identifying one or more candidate radio access nodes, candidate cells, or candidate beams that the terminal device is to use for a terminal-device-controlled mobility procedure in the event that a network-controlled mobility procedure fails.

74. The network node as set out in paragraph 73, further comprising:

a second module configured to cause the transmission, to the terminal device, of a first criterion that the terminal device is to use in determining whether the network-controlled mobility procedure has failed.

75. The network node as set out in paragraph 74, wherein the first criterion comprises one or more thresholds against which the terminal device is to compare a quality of a radio link to at least one of a serving radio access node, a serving cell, a serving beam, a target radio access node, a target cell, and a target beam.

76. The network node as set out in any one of paragraphs 73 to 75, further comprising:

a third module configured to cause the transmission, to the terminal device, of a second criterion that the terminal device is to use in determining whether to attempt to connect to one or more of the candidate radio access nodes, candidate cells, or candidate beams during the terminal-device-controlled mobility procedure.

77. The network node as set out in paragraph 76, wherein the second criterion comprises one or more thresholds against which the terminal device is to compare a quality of a radio link with one or more of the candidate radio access nodes, candidate cells, or candidate beams.

1-58. (canceled)

59. A method of operating a terminal device, the method comprising:
measuring a quality of a radio link between the terminal device and one or more candidate radio access nodes, cells or beams; and
during a network-controlled mobility procedure relating to handover of the terminal device from a first radio access node, cell or beam to a second radio access node, cell or beam, wherein the first radio access node, cell or beam and the second radio access node, cell or beam are different than the one or more candidate radio access nodes, cells or beams,
responsive to a determination that a quality of a radio link between the terminal device and at least one of the first radio access node, cell or beam and the second radio access node, cell or beam does not meet a first quality criterion, attempting to connect to one or more of the candidate radio access nodes, cells or beams for which the radio link has a measured quality that meets a second quality criterion.

60. The method as set out in claim 59, wherein the quality of the radio link comprises one or more of: a signal strength received at the terminal device; a signal-to-noise ratio for signals received at the terminal device; a signal-to-interference-plus-noise ratio; and a number of re-transmission attempts of a transport packet received at the terminal device.

61. The method as set out in claim 59, wherein the first quality criterion comprises one or more threshold values for the quality of the radio link between the terminal device and at least one of the first radio access node, cell or beam and the second radio access node, cell or beam.

62. The method as set out in claim 59, wherein a failure to meet the first quality criterion represents failure of the radio link between the terminal device and at least one of the first radio access node, cell or beam and the second radio access node, cell or beam.

63. The method as set out in claim 59, wherein the second quality criterion comprises one or more threshold values for the quality of the radio link between the terminal device and the one or more candidate radio access nodes, cells or beams.

64. The method as set out in claim 59, wherein the second quality criterion is the same as or different than the first quality criterion.

65. The method as set out in claim 59, further comprising:
receiving a list of candidate radio access nodes, cells or beams.

66. The method as set out in claim 59, further comprising:
receiving a control signal containing an indication of one or more of the first and second quality criteria.

67. The method as set out in claim 59, wherein at least one of the first and second quality criteria are contained in code stored on the terminal device.

68. The method as set out in claim 59, wherein the measuring of the quality of a radio link between the terminal device and one or more candidate radio access nodes, cells or beams is carried out responsive to the determination that the quality of the radio link between the terminal device and the at least one of the first radio access node, cell or beam and the second radio access node, cell or beam does not meet the first quality criterion.

69. The method as set out in claim 59, wherein the attempting to connect to one or more of the candidate radio access nodes, cells or beams is carried out responsive to a determination that the quality of the radio link between the terminal device and the first radio access node, cell or beam does not meet the first quality criterion.

70. The method as set out in claim 59, wherein the attempting to connect to one or more of the candidate radio access nodes, cells or beams comprises transmitting a random access signal to the one or more of the candidate radio access nodes, cells or beams.

71. The method as set out in claim 59, wherein the attempting to connect to one or more of the candidate radio access nodes, cells or beams comprises transmitting a Radio Resource Control (RRC) re-establishment request signal to the one or more of the candidate radio access nodes, cells or beams.

72. The method as set out in claim 59, further comprising:
responsive to a determination that none of the candidate radio access nodes, cells or beams has a radio link quality meeting the second quality criterion, attempting to re-establish a radio link with the first radio access node, cell or beam.

73. A terminal device comprising:
at least one antenna;
processor circuitry; and
a computer-readable storage medium, the computer-readable storage medium storing instructions that are executable by the processor circuitry whereby the terminal device is operative to:
measure a quality of a radio link between the terminal device and one or more candidate radio access nodes, cells or beams; and
during a network-controlled mobility procedure relating to handover of the terminal device from a first radio access node, cell or beam to a second radio access node, cell or beam, wherein the first radio access node, cell or beam and the second radio access node, cell or beam are different than the one or more candidate radio access nodes, cells or beams,
responsive to a determination that a quality of a radio link between the terminal device and at least one of the first radio access node, cell or beam and the second radio access node, cell or beam does not meet a first quality criterion, attempt to connect to one or more of the candidate radio access nodes, cells or beams for which the radio link has a measured quality that meets a second quality criterion.

74. The terminal device as set out in claim 73, wherein the quality of the radio link comprises one or more of: a signal strength received at the terminal device; a signal-to-noise ratio for signals received at the terminal device; a signal-to-interference-plus-noise ratio; and a number of re-transmission attempts of a transport packet received at the terminal device.

75. The terminal device as set out in claim 73, wherein the first quality criterion comprises one or more threshold values for the quality of the radio link between the terminal device and at least one of the first radio access node, cell or beam and the second radio access node, cell or beam.

76. The terminal device as set out in claim 73, wherein a failure to meet the first quality criterion represents failure of the radio link between the terminal device and at least one of the first radio access node, cell or beam and the second radio access node, cell or beam.

77. The terminal device as set out in claim 73, wherein the second quality criterion comprises one or more threshold values for the quality of the radio link between the terminal device and the one or more candidate radio access nodes, cells or beams.

78. The terminal device as set out in claim 73, wherein the second quality criterion is the same as or different than the first quality criterion.

79. The terminal device as set out in claim 73, wherein the instructions are executable by the processor circuitry such that the terminal device is further operative to:
receive a list of candidate radio access nodes, cells or beams.

80. The terminal device as set out in claim 73, wherein the instructions are executable by the processor circuitry such that the terminal device is further operative to:
receive a control signal containing an indication of one or more of the first and second quality criteria.

81. The terminal device as set out in claim 73, wherein at least one of the first and second quality criteria are contained in code stored on the terminal device.

82. The terminal device as set out in claim 73, wherein the instructions are executable by the processor circuitry such that the terminal device is further operative to:
measure the quality of a radio link between the terminal device and one or more candidate radio access nodes, cells or beams responsive to the determination that the quality of the radio link between the terminal device and the at least one of the first radio access node, cell or beam and the second radio access node, cell or beam does not meet the first quality criterion.

83. The terminal device as set out in claim 73, wherein the instructions are executable by the processor circuitry such that the terminal device is further operative to:
attempt to connect to one or more of the candidate radio access nodes, cells or beams responsive to a determination that the quality of the radio link between the terminal device and the first radio access node, cell or beam does not meet the first quality criterion.

84. The terminal device as set out in claim 73, wherein the instructions are executable by the processor circuitry such that the terminal device is further operative to:
transmit a random access signal to the one or more of the candidate radio access nodes, cells or beams.

85. The terminal device as set out in claim 73, wherein the instructions are executable by the processor circuitry such that the terminal device is further operative to:
transmit a Radio Resource Control (RRC) re-establishment request signal to the one or more of the candidate radio access nodes, cells or beams.

86. The terminal device as set out in claim 73, wherein the instructions are executable by the processor circuitry such that the terminal device is further operative to:
responsive to a determination that none of the candidate radio access nodes, cells or beams has a radio link quality meeting the second quality criterion, attempt to re-establish a radio link with the first radio access node, cell or beam.

87. A method of operating a network node in a communication network, the method comprising:
causing the transmission, to a terminal device, of a list identifying one or more candidate radio access nodes, cells or beams that the terminal device is to use for a terminal-device-controlled mobility procedure in the event that a network-controlled mobility procedure fails.

88. The method as set out in claim 87, further comprising:
causing the transmission, to the terminal device, of a first criterion that the terminal device is to use in determining whether the network-controlled mobility procedure has failed.

89. The method as set out in claim 88, wherein the first criterion comprises one or more thresholds against which the terminal device is to compare a quality of a radio link to at least one of a serving radio access node, cell or beam and a target radio access node, cell or beam.

90. The method as set out in claim 87, further comprising:
causing the transmission, to the terminal device, of a second criterion that the terminal device is to use in determining whether to attempt to connect to one or more of the candidate radio access nodes, cells or beams during the terminal-device-controlled mobility procedure.

91. The method as set out in claim 90, wherein the second criterion comprises one or more thresholds against which the terminal device is to compare a quality of a radio link with one or more of the candidate radio access nodes, cells or beams.

92. A network node comprising:
processor circuitry; and
a computer-readable storage medium, the computer-readable storage medium storing instructions that are executable by the processor circuitry whereby the network node is operative to:
cause the transmission, to a terminal device, of a list identifying one or more candidate radio access nodes, cells or beams that the terminal device is to use for a terminal-device-controlled mobility procedure in the event that a network-controlled mobility procedure fails.

93. The network node as set out in claim 92, wherein the instructions are executable by the processor circuitry such that the network node is further operative to:
cause the transmission, to the terminal device, of a first criterion that the terminal device is to use in determining whether the network-controlled mobility procedure has failed.

94. The network node as set out in claim 93, wherein the first criterion comprises one or more thresholds against which the terminal device is to compare a quality of a radio link to at least one of a serving radio access node, cell or beam and a target radio access node, cell or beam.

95. The network node as set out in claim 92, wherein the instructions are executable by the processor circuitry such that the network node is further operative to:
cause the transmission, to the terminal device, of a second criterion that the terminal device is to use in determining whether to attempt to connect to one or more of the candidate radio access nodes, cells or beams during the terminal-device-controlled mobility procedure.

96. The network node as set out in claim 95, wherein the second criterion comprises one or more thresholds against which the terminal device is to compare a quality of a radio link with one or more of the candidate radio access nodes, cells or beams.
